(19) United States
(12) Patent Application Publication
(10) Pub. No.: US 2011/0217973 A1
(43) Pub. Date: Sep. 8, 2011

(54) Radio Link Monitoring in DRX

(75) Inventors: Mats Sågfors, Kyrkslätt (FI); Vera Vukajlovic Kenehan, Stockholm (SE)

(73) Assignee: TELEFONAKTIEBOLAGET LM ERICSSON (PUBL), Stockholm (SE)

(21) Appl. No.: 13/128,276

(22) PCT Filed: Sep. 22, 2009
(86) PCT No.: PCT/SE09/51050

§ 371 Date: May 9, 2011

Related U.S. Application Data
(60) Provisional application No. 61/112,826, filed on Nov. 10, 2008.

(51) Int. Cl. H04W 24/00

(52) U.S. Cl. 455/423

(57) ABSTRACT

The present invention provides a higher protocol layer, e.g. Layer 3, filter mechanism, where a counter mechanism applied in the filter adapts an incremental or decremental process of the relevant counter or counters to the inter-arrival time of the consecutive out of synch resp. in synch indications from a lower protocol layer, e.g. Layer 1, since the indications from the lower protocol layer may arrive to the higher-layers with irregular arrival times.

### FIELD OF THE INVENTION

The present invention relates to radio link monitoring, in particular to detection of radio link failure (RLF) in a cellular communication system.

### BACKGROUND

In wireless communication, irrespective of which wireless or mobile communication system is used, radio link monitoring is vital to maintain radio connections. By regularly reporting the radio conditions to the system, different types of actions can be taken when radio link failure occur. In e.g. UTRA (UMTS Terrestrial Radio Access Network), the physical layers estimate the quality of the radio links and report, on radio frame basis, the synchronisation status to higher layers. The synchronization status are reported via so called synchronisation primitives which are described in greater details in the technical specification 3GPP TS 25.214 V7.4.0 entitled: “Physical Layer Procedures (FDD)”.

The mechanism of reporting radio link quality status is also specified in E-UTRA (Evolved UTRA), in which a fast and reliable detection of radio problems is considered essential in order to avoid unnecessary interference in uplink, waste of resources in downlink and unnecessarily long delays before e.g. cell reselection or handover of a UE can take place.

Thus, in wireless networks such as UTRAN and GERAN, there are methods defined for a User Equipment, UE, to monitor the link quality to the serving cell. In such mechanisms, a UE may monitor the link quality to the serving cell e.g. by measuring the quality of a pilot signal sent from in the serving cell by the base-station. If the link quality on this physical layer, in the following referred to as Layer 1, L1, is getting worse than some defined threshold, then the physical layer in the UE reports this event to higher layers, such that higher layers in the UE may act in an appropriate way. Such actions may include that the UE stops all UL transmissions or that the UE re-establishes or recovers the connection, for example by selecting another cell. This functionality is needed to monitor the link quality during an ongoing connection, such that the UE may for example release the connection if the quality is getting too bad.

Using UTRAN as a specific example of this functionality, in TS 25.331, Section 8.5.6 (Radio link failure criteria and actions upon radio link failure), there is specified a method for such radio link monitoring. Layer 1 reports “out of synch” in case the Layer 1 evaluation finds that the radio link quality goes below certain specified quality thresholds. Similarly, Layer 1 reports “in synch” at times when the radio link quality evaluation on Layer 1 finds that the quality of the link has improved according to specified quality thresholds.

It may happen that the UE is experiencing varying radio conditions such that the L1 evaluation results in frequent toggling between “out of synch” and “in synch” indications. In order to prevent that the UE takes frequent, and sometimes possibly premature actions to such indications, there has been defined a Layer 3, L3, filtering method of these indications. Specifically, it is possible to configure the UE to take appropriate actions on L3 only if multiple indications of the same kind (i.e. either “out of synch” or “in synch”) are received consecutively, i.e. without intermediate indication of the opposite status. In UTRAN, a timer T313 is started only if N313 consecutive “out of synch” indications are received. This stage is in this text referred to as a radio link problem is recognized. Similarly, if T313 is running, then the timer is stopped only if N315 consecutive “in synch” indications are received.

If the timer T313 expires, then a radio link failure is declared.

An extract of the UTRAN solution as specified in TS25.331, v. 8.4.0 is provided below:

### “8.5.6 Radio Link Failure Criteria and Actions Upon Radio Link Failure

In CELL DCH state, after receiving N313 consecutive “out of sync” indications from layer 1 for the established DPCCH or F-DPCH physical channel in FDD, and the physical channels associated with mapped DCCHs in TDD, the UE shall:
1> start timer T313;
1> upon receiving N315 successive “in sync” indications from layer 1 and upon change of UE state:
   2> stop and reset timer T313.
1> if T313 expires:
   2> consider it as a “Radio link failure”.

Periods in time where neither “in sync” nor “out of sync” is reported by layer 1 do not affect the evaluation of the number of consecutive (resp. successive) “in sync” or “out of sync” indications.”

An alternative way of L3 filtering is the so called GERAN approach, where UE maintains a single counter configured to a level that is decremented by a value when L1 provides out-of-synch indication and incremented by same or a different value when in-synch indication is provided from L1 to upper layer. When the counter reaches 0, a radio link problem is recognized and a timer T310 is started. If the counter reaches a value of radio link recovery before the timer has expired, the timer is stopped.

With the UTRAN solution as a baseline, we note that in LTE, i.e. E-UTRAN, the first counter counting “out of synch” indications may be called n310 (corresponding to UTRAN n313), the LTE timer to be started when radio link problem is recognized on L3 may be called T310 (corresponding to UTRAN T313), the second counter counting “in synch” indications in LTE may be called n311 (corresponding to UTRAN n315) and a second timer for link recovery to be started when a Radio Link Failure has been declared may be called T311 in LTE.

In contrast to UTRAN, LTE will support considerably longer DRX periods also in CONNECTED state. DRX means that the UE is allowed to apply inactive periods during which battery can be saved, such that the UE is only periodically required to “wake up” to engage the receiver for reading e.g. a control channel carrying e.g. potential scheduling assignments. Two different DRX “states” have been specified for LTE, one “long” DRX, and one “short” DRX period. Depending e.g. on user-activity, the UE may switch between non-DRX, short-DRX and long-DRX. The DRX periods, the activity time during periods, including thresholds and triggers for stepping between non-DRX and the two DRX configurations are configured by higher layers, i.e. the RRC protocol.

In order for such DRX to be efficient, the aforementioned radio link evaluation mechanism on L1 is also affected. It is clear that the terminal cannot continuously measure the radio link quality during DRX periods if the power-preserving gains of the DRX periods are to be materialized.

Therefore, it may be specified that a terminal will be allowed to report the aforementioned L1 indications (“out of synch” and “in synch”) less frequently when the UE is in DRX mode. This is proposed e.g. in the 3GPP contribution paper R1-084739 (“Radio link monitoring”). It has also been agreed to support less stringent radio link quality measurements during DRX periods, as reflected in the 3GPP contribution paper R4-083004 (“Radio Link Monitoring Minimum Requirements”).

With the solution in R1-084739, the UE is required to provide the relevant indications to L3 only once during the DRX period. DRX periods can be configured to the values ranging from 10 milliseconds up to 2.56 seconds. The present configurable range of the DRX period is {10, 32, 40, 64, 80, 128, 160, 256, 320, 512, 640, 1024, 1280, 2048, 2560} milliseconds.

The fact that Layer 1 may provide L1 indications with very diverse intervals poses a problem for the L3 filter design, as illustrated with the following example:

Suppose it is found that, while T310 is running and the UE is not in DRX, five consecutive indications of “in synch” indications (configured via a parameter hereafter called N311) are considered sufficiently robust to declare a recovery of the link such that T310 would be stopped. In non-DRX, such five consecutive indications are received in only 50 milliseconds.

However, if the same UE is in long DRX with, say, a DRX period of 1.28 seconds, it means that more than six seconds will pass before five consecutive indications have been received and the timer T310 can be stopped. On the other hand, a value of T310 exceeding six seconds may not be appropriate at all if the UE is active and there is a desire to have a quick recovery, e.g. through an RRC Re-establishment, from radio problems. Thus, different reporting intervals from Layer 1 make it difficult to find L3 filter parameters that are useful both in non-DRX and DRX mode.

In the alternative using a single counter solution as in case of GERAN, the counter could be set to e.g. value 5, Also in this case, the time to count will depend on the inter-arrival time of the Layer 1 indications, thus posing a problem to set the counter to a value that is useful in both in non-DRX and DRX modes. The counter may be referred to as ng310 using known terminology.

Returning to the UTRAN solution, in another example, using e.g. a value 10 for N310 may be appropriate for a UE in non-DRX, as the UE will robustly detect, i.e. recognize, a radio problem after ten consecutive “out of synch” indications from L1. These ten indications will only delay the recognition of the radio link problem (and start of T310) with 100 milliseconds when the UE is not in DRX mode. However, if the same UE uses a DRX period of 2.56 seconds, the problem detection on L3 and the start of T310 will be delayed by more than 25 seconds. Such delays could adversely affect the end-user experience, since the UE might have moved very far from the serving cell during this time. During this period, the UE is not reachable, as the UE is not allowed to select a more suitable cell before the radio link failure is declared.

### SUMMARY

It is therefore an object of the present invention to provide a method and arrangement for detection of Radio Link Failure using higher layer filtering that operates well in diverse DRX conditions.

A first aspect of the invention relates to a method for radio link monitoring in a User Equipment, UE, configured to operate in DRX mode, where a lower protocol layer may provide indications to a higher protocol layer of radio problems and recovery from such problems. The method comprises the steps of
in the higher protocol layer, receiving an indication of radio link problem from the lower layer;
adjusting a first counter with a value;
when the counter reaches a certain level, recognizing a radio link problem on the higher protocol level;
   wherein the value by which the counter is adjusted is dependent on the time elapsed since the last received indication from the lower layer that caused adjustment of said counter.

A first specific embodiment of the invention comprises the following steps:
adjusting said first counter in a first direction upon reception of an indication of radio problem from the lower layer;
adjusting said first counter in an opposite direction upon reception of an indication of radio link recovery.

Thus, according to this embodiment, a single counter is maintained, wherein said counter is decremented or incremented dependent of if the indication from the lower protocol layer is an indication of radio link problem, i.e. an out-of synch indication or an indication of radio link recovery, i.e. an in synch indication.

The specific embodiment described above may also comprise the steps of
starting a timer when the counter has reached the certain level;
stopping the timer if said counter reaches a certain level defining radio link recovery before expiration of the timer, otherwise,
declaring radio link failure upon expiration of said timer.

A second specific embodiment comprises the steps of
for each consecutive indication of radio link problem, adjusting said first counter with a value that is dependent on the time elapsed since the last consecutive indication on radio problem;
when said first counter reaches a certain level, recognizing a radio link problem on the higher protocol level;
for each consecutive indication of radio link recovery received from the lower layer after the recognition of radio link problem on the higher protocol level, adjusting a second counter with a value that is dependent on the time elapsed since the last received consecutive indication on radio link recovery;
when said second counter reaches a certain level, the recognition of radio link problem is revoked on the higher protocol level.

Thus, according to this embodiment, two counters are maintained, whereby the second counter starts to count consecutive indications of link recovery upon recognition of radio link problem at the higher protocol layer, i.e. when the first counter has reached a certain level.

The specific embodiment described above may comprise the steps of
starting a timer when the first counter has reached the certain level;
stopping the timer if said second counter reaches a certain level defining radio link recovery before expiration of the timer, otherwise,
declaring radio link failure upon expiration of said timer.

The first counter may be reset to an initial value upon reception of a non-consecutive indication of radio link problem or radio link recovery.

The value by which a counter is adjusted may be proportional to the number of radio frames that have passed since reception of the last received radio link indication from the lower layer that caused adjustment of the relevant counter. In a specific embodiment, the value by which a counter is adjusted is equal to the number of radio frames passed since reception of the last received radio link indication from the lower layer that caused adjustment of the relevant counter.

Different weights may be applied to the values by which a counter is adjusted dependent on if the adjustment is triggered by an indication of radio link problem or radio link recovery. For example, for each indication of radio link recovery, a weight factor of two is applied to the value by which the relevant counter is adjusted.

Another aspect of the invention relates to an arrangement in a User Equipment, UE, configured to operate in DRX mode, wherein a lower protocol layer may provide indications to a higher protocol layer of radio problems and recovery from such problems. The arrangement comprises
a unit for receiving, in the higher protocol layer, an indication of radio link problem from the lower layer;
a unit for adjusting a first counter with a value upon reception of such indication;
a unit for recognizing a radio link problem on the higher protocol level when the counter reaches a certain level;

The value by which the counter is adjusted is dependent on the time elapsed since the last received indication from the lower layer that caused adjustment of said counter.

According to a specific. embodiment, a first counter is provided to be adjusted for each consecutive indication of radio link problem with a value that is dependent on the time elapsed since the last consecutive indication on radio problem, while a second counter is provided to be adjusted for each consecutive indication of radio link recovery received from the lower layer after the recognition of radio link problem on the higher protocol level with a value that is dependent on the time elapsed since the last received consecutive indication on radio link recovery.

A timer may be provided to be started upon recognition of radio link problem at the higher protocol layer; such that a unit may declare radio link failure if the timer expires before the relevant counter has reached a certain level defining radio link recovery.

Thus, embodiments of the invention provides a higher protocol layer, e.g. Layer 3, filter mechanism, where the counter mechanism applied in the filter adapts an incremental or decremental process of the relevant counters to the inter-arrival time of the consecutive “out of synch” resp. “in synch” indications from a lower protocol layer, e.g. Layer 1, since the indications from the lower protocol layer may arrive to the higher-layers with irregular arrival times.

Other objects, advantages and novel features of the invention will become apparent from the following detailed description of the invention.

### BRIEF DESCRIPTION OF THE DRAWINGS

The foregoing and other objects, features and advantages of the invention will be apparent from the following detailed description of embodiments as illustrated in the drawings.

FIG. 1 shows a flowchart of a first embodiment of the invention.

FIG. 2 shows a flowchart of a second embodiment of the invention.

FIG. 3 shows a block diagram illustrating a first embodiment of an arrangement in a User Equipment.

FIG. 4 shows a block diagram illustrating a second embodiment of an arrangement in a User Equipment.

### DETAILED DESCRIPTION

The present invention can be exemplified in the following non-limiting description of embodiments of the invention.

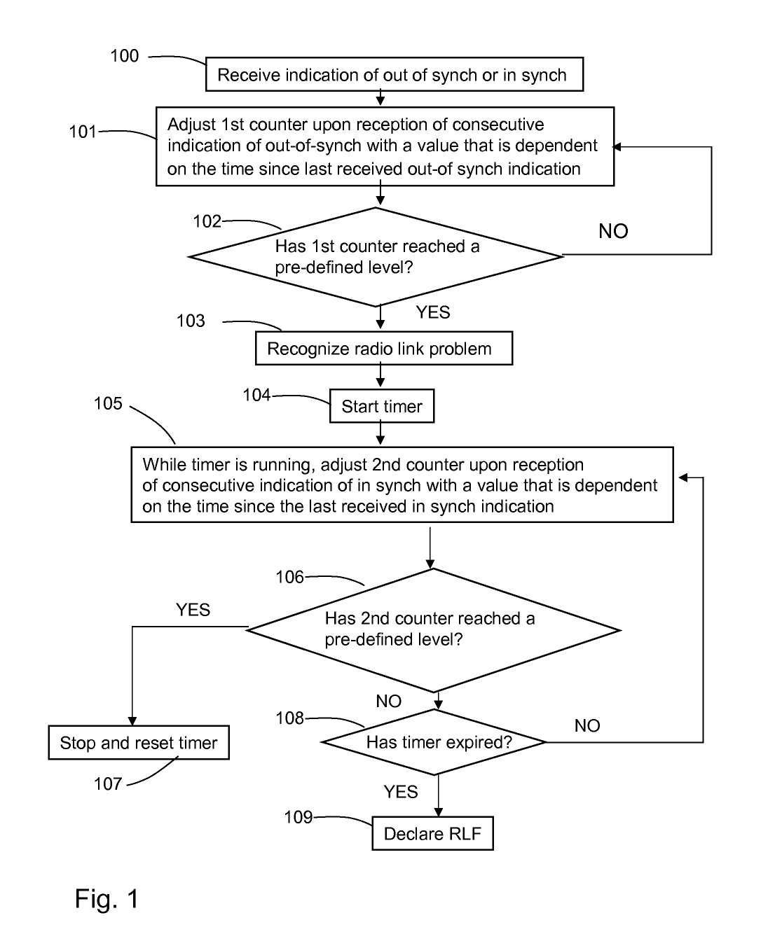

In the first example given herein, shown in FIG. 1, the UTRAN approach for Layer 3 filtering is assumed, but it should be noted that embodiments of the present invention are not constrained to the UTRAN approach with two separate counters that are incremented, but the solution is equally well applicable to a solution where for example a single counter is incremented or decremented for “out of synch” and “in synch” indications, respectively, as will be described later.

An embodiment of a method of counting, in a higher protocol layer, consecutive indications of radio problems (out-of synch) received from a lower protocol layer is illustrated FIG. 1 according to in the following:

The lower-protocol layer may provide indications of radio problems (out-of-synch) and indications of recovery from radio problems (in-synch). In step 101, a counter, e.g. n310, is for each consecutive indication of radio link problem, i.e. out of synch indication, incremented with a value that is proportional to the time spent since the last received consecutive indication of radio link problem. If the counter reaches or exceeds a certain value, e.g. N310, see step 102, then a radio link problem is recognized on the higher-protocol layer, step 103. Upon recognition of radio link problem, a timer, e.g. T310, may be started, step 104. In step 105, while the timer T310 is running, a second counter, e.g. n311 is, for each consecutive indication of radio link recovery, i.e. in synch indication, incremented with a value that is proportional to the time spent since the last received consecutive indication of radio link recovery. If the second counter reaches or exceeds a certain value, e.g. N311, see step 106, then the timer T310 is stopped and the recognition of radio link problem on the higher-protocol layer is revoked, see step 107. This can also be expressed such as an issuance of a declaration of radio recovery on the higher protocol layer. If, on the other hand, the timer T310 expires before the second counter has reached or exceeded the certain value N311, see step 108, a declaration of radio link failure is issued at step 109 whereby a second timer T311 for link recovery is started in accordance with known procedures.

For each non-consecutive indication of “out of synch” or “in sync”, the relevant counter (n310 or n311) is initialized to 1.

The certain values, e.g. N310, N311, that define levels for recognition of radio link problem and radio link recovery for the first and second counter respectively may be configurable values set by the network. Alternatively the values may be set by a standard and are thereby known to the UE.

The value that is proportional to the time spent since the last received consecutive indication, with which the counter in question is incremented, may be a value equal to the number of radio frames since the last received consecutive indication of radio problems or a value that is proportional to said number of radio frames.

The embodiment assuming the UTRAN approach for layer 3 filtering may be illustrated by the following non-limiting example:

| frame | indication | N310 |
|---|---|---|
| 20 | (first) out-of-synch | n310 = 1 |
| 21 | out-of-synch | n310 = n310 + 1 |
| 22 | synch | n310 = 1 (n310 reset) |
| 23 | none | |
| 24 | out-of-synch | n310 = 1 |
| 25 | none (DRX) | |
| 26 | none (DRX) | |
| 27 | none (DRX) | |
| 28 | out-of-synch | n310 = n310 + 4 |
| 29 | none (DRX) | |
| 30 | out-of-synch | n310 = n310 + 2 |
| 31 | out-of-synch | n310 = n310 + 1 |
| 32 | none (DRX) | |
| 33 | out-of-synch | n310 = n310 + 2 |

A particular embodiment of the above could be to apply different weights to the values used for adjusting the first and the second counter respectively. For example, for adjusting the first counter, e.g. n310, a factor of one is applied to the value, while for adjusting the second counter, e.g. n311, a factor of two is applied to the adjustment value.

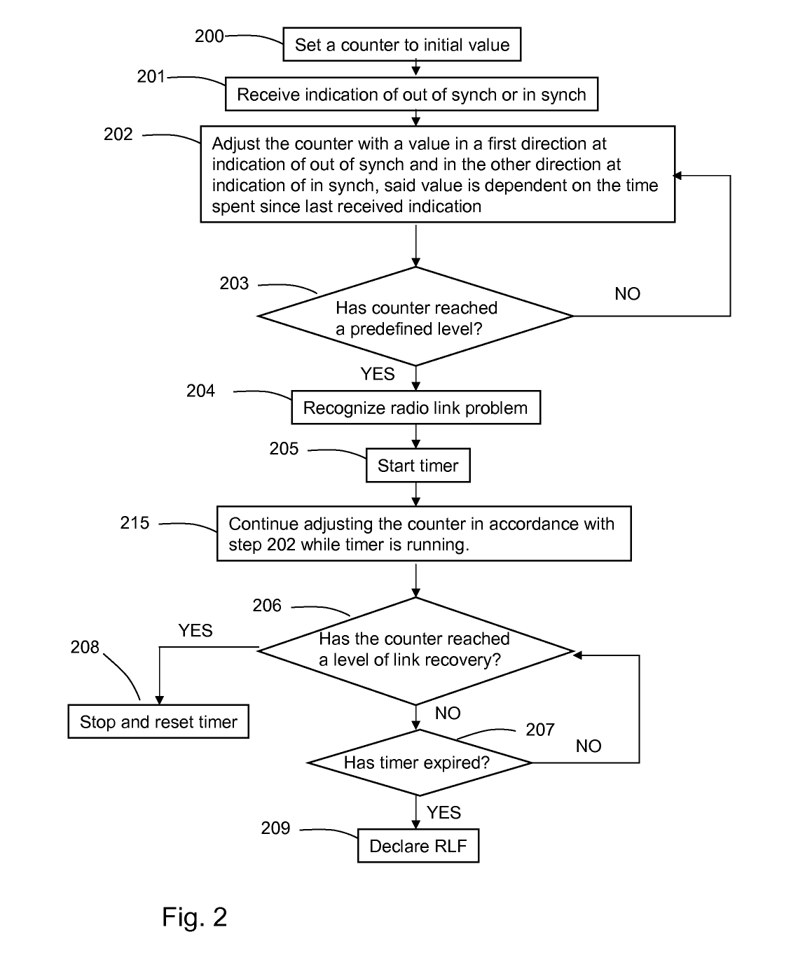

In an alternative embodiment, illustrated in FIG. 2, it is assumed that the GERAN approach for layer 3 filtering is used, wherein a single counter is used. Said counter is incremented or decremented dependent on if an indication of radio link problem or radio link recovery is received.

With reference to FIG. 2, in step 201 a counter is initialized to a configured value, e.g. NG310. Said value may be a configurable value set by the network, or it may be set by a standard and is thereby known to the UE. In step 202, the counter is adjusted with a value in a first direction, e.g. decremented, upon reception of an indication of out-of-synch while the counter is adjusted with a value in a second direction, e.g. incremented, upon reception of an indication of in-synch. The value by which the counter is incremented or decremented is dependent on the time spent since the last received indication of either out-of-synch or in-synch, i.e. said value is based on the inter-arrival of the indications from the lower protocol layer. In contrast to the UTRAN approach illustrated in FIG. 1, in the GERAN approach it is irrelevant whether the whether the indications of out-of-synch and in-synch are consecutive or not, since there is only one counter. The counter is adjusted only within a range defined by the initial value and a certain value defining a level where radio link problem is recognized, e.g. zero. In step 203, it is evaluated if the counter has reached said certain level, which for example could be zero. If the counter has reached the certain level, a radio link problem is recognized on the higher-protocol layer, step 204, and the counter is not decremented further. Upon recognition of radio link problem, a timer, e.g. T310, may be started, step 205. While the timer is running, the counter is continuously adjusted, step 515, upon reception of indications of in synch and out of synch respectively in the same way as indicated for step 202. In step 206 it is evaluated if the counter has reached a value defined for Radio Link Recovery. If this is the case, the timer is stopped and the recognition of radio link problem is revoked. The counter is not incremented further after reaching the value defined for Radio Link Recovery. If the counter has not reached said value before the timer has expired, see step 207, radio link failure is declared in step 208.

Specifically, a solution according to this approach includes the mechanism of incrementing or decrementing the counter with the value that is equal to the number of radio frames that has passed since the previously received indication from Layer 1 or a value that is proportional to said number of radio frames.

This alternative embodiment, i.e. assuming the GERAN approach for layer 3 filtering, may be illustrated by the following non-limiting example:

| frame | indication | NG310 |
|---|---|---|
| 20 | (first) out-of-synch | ng310 = 5 |
| 21 | out-of-synch | ng310 = ng310 − 1 |
| 22 | synch | n310 = n310 + 1 |
| 23 | none | same |
| 24 | out-of-synch | ng310 = ng310 − 1 |
| 25 | none (DRX) | |
| 26 | none (DRX) | |
| 27 | none (DRX) | |
| 28 | out-of-synch | ng310 = ng310 − 4 |

At this point, counter reached 0 value and radio link problem, is recognized on the higher-protocol layer.

In a specific embodiment, it could be defined that the incremental and decremental process have different step-sizes, e.g. such that for each indication of in-synch, the relevant counter is adjusted in a first direction, e.g. incremented, by a value which is two times the number of frames since the previous relevant event. In the same example, the step size when adjusting the counter in a second direction, e.g. decrementing the counter, could still be one times the number of frames since the previous relevant event.

The following is an example of how the invention according to the first embodiment could be implemented in a standard specification:

If T310 is not running and an “out of sync” indication is received from Layer 1, the UE shall:
1> If the indication is a consecutive “out of synch” indication
   2> increment the counter n310 with the number of frames since the previous reception of an “out of synch” indication;
1> Else
   2> set n310 to 1.
1> If n310 is greater or equal to N310
   2> start a timer T310.

If T310 is running and an “in sync” indication is received from Layer 1, the UE shall:
1> If the indication is a consecutive “in synch” indication
   2> increment the counter n311 with the number of frames since the previous reception of an “in synch” indication;
1> Else
   2> set n311 to 1.
1> If n311 is greater or equal to N311
   2> stop timer T310.

In this case, the UE resumes the RRC connection without explicit signalling i.e. the UE resumes the entire radio resource configuration.

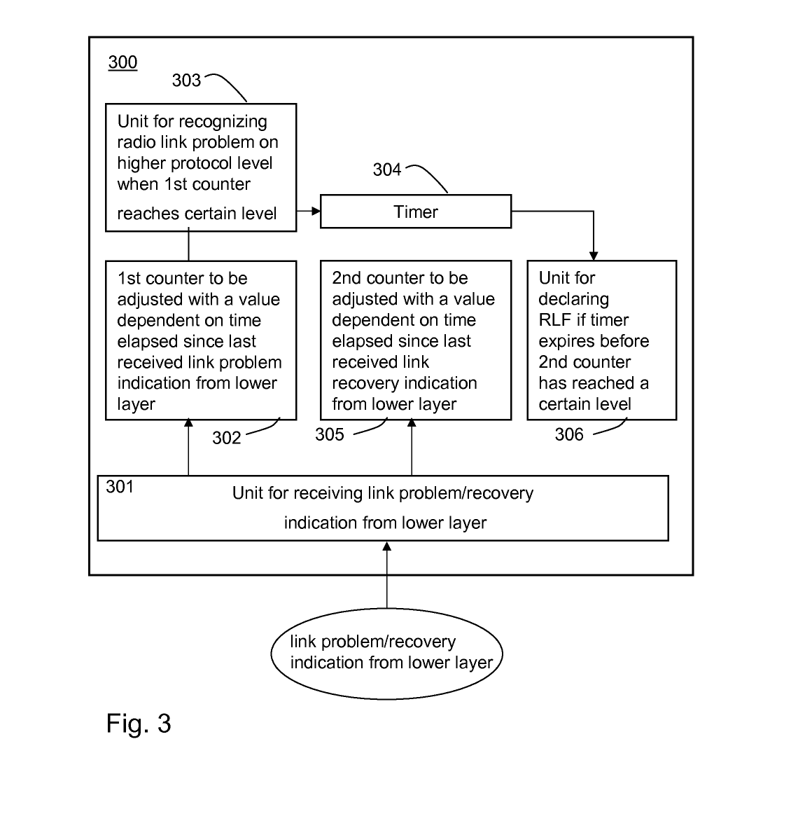

FIG. 3 illustrates an arrangement according to a specific embodiment of the invention. FIG. 3 shows a mechanism in a higher protocol layer, e.g. layer 3, in an arrangement 300 in a user equipment, UE. Said arrangement comprises a unit 301 for receiving indications of radio link problem or recovery from a lower protocol layer. The arrangement furthermore comprises a first counter 302 to be adjusted with a value upon reception of a consecutive indication of radio link problem, i.e. out of synch indication. Said value is dependent on the time that has elapsed since last received link problem indication from the lower layer. The arrangement furthermore comprises a unit 303 for recognizing radio link problem on higher protocol level when the first counter 302 reaches a certain level. A timer 304 may be provided that is configured to start upon recognition of radio link problem. A second counter 305 is provided to be adjusted for each consecutive indication of radio link recovery, i.e. in synch, received from the lower layer after the recognition of radio link problem on the higher protocol level with a value that is dependent on the time elapsed since the last received consecutive indication on radio link recovery. A unit 306 is arranged to declare radio link failure, RLF, if the timer 304 expires before the second counter 305 has reached a certain value.

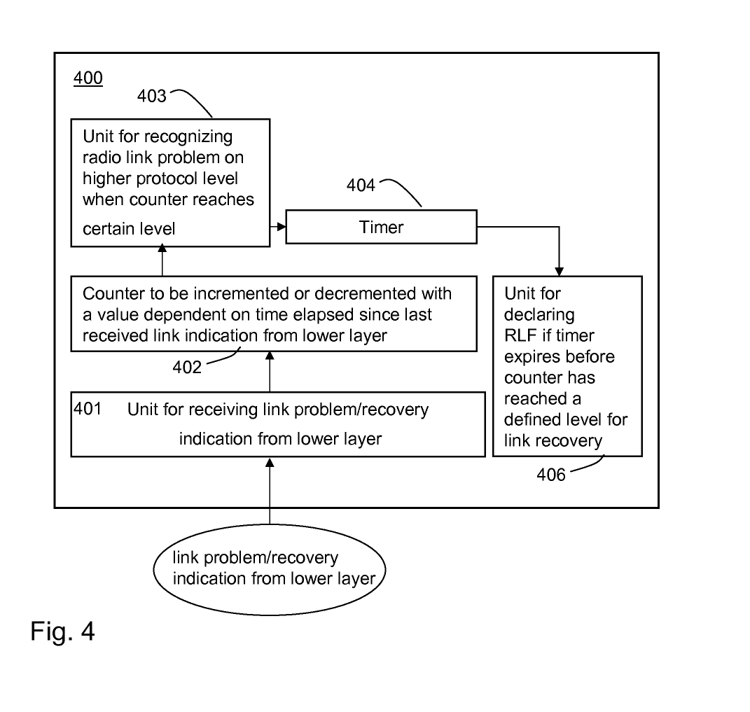

An arrangement 400 according to an alternative embodiment is illustrated in FIG. 4. The higher protocol layer mechanism according to this embodiment comprises a unit 401 for receiving indications of radio link problem or recovery from a lower protocol layer. The arrangement furthermore comprises a counter 402 to be adjusted with a value upon reception of an indication of radio link problem or recovery. The arrangement furthermore comprises a unit 403 for recognizing radio link problem on higher protocol level when the counter 402 reaches a certain level. A timer 404 may be provided that is configured to start upon recognition of radio link problem. A unit 406 is arranged to declare radio link failure, RLF, if the timer 404 expires before the counter 402 has reached a value defined for link recovery.

For the sake of clarity, any internal electronics of the arrangement 300 not necessary for understanding the embodiments of the invention has been omitted from FIGS. 3 and 4.

The present invention may, of course, be carried out in other ways than those specifically set forth herein without departing from essential characteristics of the invention. The present embodiments are to be considered in all respects as illustrative and not restrictive.

1-13. (canceled)

14. A method for radio link monitoring in a User Equipment configured to operate in discontinuous reception mode, wherein a higher protocol layer receives indications from a lower protocol layer regarding radio link problems and recovery from those problems, wherein the method comprises:
at the higher protocol layer, receiving from the lower protocol layer one or more indications of a radio link problem;
adjusting, for each received indication, a first counter with a value that depends on the time elapsed since having last received an indication of a radio link problem from the lower protocol layer that caused adjustment of the first counter; and
recognizing a radio link problem at the higher protocol level responsive to the first counter reaching a first level.

15. The method according to claim 14, wherein said adjusting comprises adjusting said first counter in a first direction based on having received an indication of a radio link problem, and wherein the method further comprises:
at the higher protocol layer, receiving from the lower protocol layer one or more indications of radio link recovery; and
adjusting said first counter in a second direction, opposite the first direction, based on having received an indication of radio link recovery.

16. The method according to claim 15, further comprising:
starting a timer responsive to the first counter reaching the first level;
stopping the timer responsive to said first counter reaching a second level defining radio link recovery before expiration of the timer, and
declaring radio link failure responsive to expiration of said timer.

17. The method according to claim 14, wherein said adjusting comprises adjusting, for each consecutively received indication of a radio link problem, said first counter with a value that depends on the time elapsed since having last received a consecutive indication of a radio link problem, and wherein the method further comprises:
at the higher protocol layer and after having recognized said radio link problem, receiving from the lower protocol layer one or more indications of radio link recovery;
adjusting, for each consecutively received indication of radio link recovery, a second counter with a value that depends on the time elapsed since having last received a consecutive indication of radio link recovery; and
revoking recognition of said radio link problem responsive to said second counter reaching a second level.

18. The method according to claim 17, further comprising:
starting a timer responsive to the first counter reaching the first level;
stopping the timer responsive to said second counter reaching a second level defining radio link recovery before expiration of the timer, and
declaring radio link failure responsive to expiration of said timer.

19. The method according to claim 17, further comprising resetting the first counter to an initial value upon reception of a non-consecutive indication of a radio link problem or radio link recovery.

20. The method according to claim 14, wherein the value by which the first counter is adjusted is proportional to the number of radio frames that have passed since reception of the last received indication from the lower layer that caused adjustment of the first counter.

21. The method according to claim 20, wherein the value by which the first counter is adjusted is equal to the number of radio frames passed since reception of the last received indication from the lower layer that caused adjustment of the first counter.

22. The method according to claim 14, wherein the method further comprises, at the higher protocol layer, receiving from the lower protocol layer one or more indications of radio link recovery, and wherein different weights are applied to the values by which the first counter is adjusted depending on if the adjustment is triggered by an indication of a radio link problem or radio link recovery.

23. The method according to claim 22, wherein for each indication of radio link recovery, a weight factor of two is applied to the value by which the first counter is adjusted.

24. A User Equipment configured to operate in discontinuous reception mode and to count at a higher protocol layer indications received from a lower protocol layer regarding radio link problems and recovery from those problems, comprising
a first unit configured to receive, at the higher protocol layer and from the lower protocol layer one or more indications of a radio link problem;
a first counter configured, for each received indication, to be adjusted with a value that depends on the time elapsed since having last received an indication of a radio link problem from the lower protocol layer that caused adjustment of the first counter; and
a second unit configured to recognize a radio link problem at the relatively higher protocol level responsive to the first counter reaching a first level.

25. The User Equipment according to claim 24, wherein the first counter is configured, for each consecutively received indication of a radio link problem, to be adjusted with a value that depends on the time elapsed since having last received a consecutive indication of a radio link problem, wherein the first unit is further configured to receive, at the higher protocol layer and after having recognized said radio link problem, receive one or more indications of radio link recovery from the lower protocol layer, and wherein the User Equipment further comprises a second counter configured, for each consecutively received indication of radio link recovery, to be adjusted with a value that depends on the time elapsed since having last received a consecutive indication of radio link recovery.

26. The User Equipment according to claim 24, further comprising:
a timer configured to be started responsive to the first counter reaching the first level and to be stopped responsive to said first counter reaching a second level defining radio link recovery before expiration of the timer, and
a third unit configured to declare radio link failure responsive to expiration of said timer.
